(19) United States
(12) Patent Application Publication
(10) Pub. No.: US 2002/0116626 A1
(43) Pub. Date: Aug. 22, 2002

(54) Authentication system, method and apparatus

(76) Inventor: Roger D. Wood, Laurel, MD (US)

Correspondence Address: Derek J. Jardieu, HOWREY & SIMON, 1299 Pennsylvania Avenue, N.W., Box No.34, Washington, DC, 20004-2402, US

(21) Appl. No.: 09/781,201

(22) Filed: Feb. 13, 2001

(51) Int. Cl. H04L 9/32

(52) U.S. Cl. 713/200

(57) ABSTRACT

An authentication device and associated system and method for authentication. The authentication device may be used to verify that a possessor thereof is authorized to receive a prearranged entitlement. The possessor may be entitled to a good or service, access to a location, a discount, etc. Verification and arrangement may occur through communication with a central server, initiated by the authentication device, from any of a plurality of remote interfaces. In one embodiment, the present invention may replace a traditional paper ticketing system and improve efficiency by regulating admittance to an access-controlled venue with the reusable authentication device. An authentication device of such a system preferably includes a display for providing information, including that which might be found on a traditional paper ticket and/or ticket stub.

### BACKGROUND OF THE INVENTION

1. Field of the Invention

The present invention relates generally to an authentication system, method and apparatus. More specifically, the present invention relates to a smartcard or other authentication device having a display, and an associated, widely applicable system and method for authentication and related features and functionality.

2. Related Art

Authentication systems are known in which various means are used to demonstrate an individual's entitlement to a product or service or eligibility for discounts on the same, authorization to enter a particular location, proof of purchase, etc. For example, ticketing systems are known whereby a customer is presented a paper ticket or other physical object upon payment. These tickets may allow the possessor admission to a concert hall, theater or other such venue or event; grant access to an airplane, train or other mode of transport; prove ownership of a physical item, such as a checked coat or valet-parked car; and others. However, each of these systems suffers the drawback that the paper tickets or other physical objects presented have limited usefulness in that they are often used once and discarded, and are rarely available for more than one particular purpose each.

More recently, systems have been developed in which a single physical object, such as a smartcard, is provided which can be enabled for multiple purposes. Smartcards may be, for example, comparable in size to a credit card, and may be programmed to entitle a possessor to access to multiple venues, to discounts in multiple locations, and other features of more general applicability. However, these smartcards are often practical only in generic environments, such as for access to general admission venues, or where certain discounts are offered to a large audience.

One limitation, for example, derives from an inability of these smartcards to be enabled for such specific data as seat and row information, or to display the same or other information to a holder of the smartcard and/or to personnel, for example, such as may be responsible for restricting access to a venue or area thereof. Furthermore, any displays that may be available on such smartcards typically require an application of power in order to access stored information. These inefficiencies preclude the applicability of such smartcard systems to many environments. Thus, while known smartcard systems provide certain advantages over paper ticketing arrangements, these systems often lack such desirable features as even wider applicability and active provision of information to a possessor or other viewer of the card.

What is needed is an authentication device and associated system and method whose applicability can be greatly expanded by enabling the authentication device to display certain useful information and to actively modify and/or update the information as necessary.

### SUMMARY OF THE INVENTION

The present invention is an authentication device and associated system and method. In one aspect, the present invention provides a portable authentication device having a body, a contact area disposed in the body and an identification portion disposed in the body. The device also preferably includes an active display area disposed in said body, wherein the active display area is enabled for bistable performance, and a processor, also disposed in the body, for providing data to the active display area, among other features and functions.

In another aspect, the present invention provides an authentication system that includes a portable authentication device having an active display, a database server and an authentication device data interface, which couples the portable authentication device and the database server.

In yet another aspect, the present invention provides a method for authenticating a user or patron. The method includes providing an authentication device having an active display. The method further includes updating a database server with authentication data associated with a venue and displaying display data corresponding to the authentication data on the authentication device. The method also includes establishing a communication between the authentication device and the database server and deciding whether to grant the patron access to the venue based on the communication.

Other systems, methods, features and advantages of the invention will be or will become apparent to one skilled in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, and are illustrative rather than limiting. Emphasis is instead being placed upon broadly illustrating the principles of the invention. Moreover, in the figures, like reference numerals designate corresponding parts throughout the different views.

FIG. 1 is a block diagram illustrating an embodiment of an authentication system of the present invention;

FIG. 2A is a perspective view illustrating an obverse side of an embodiment of an authentication device of the present invention;

FIG. 2B is a perspective view illustrating a reverse side of an embodiment of an authentication device of the present invention;

FIG. 2C is a perspective view illustrating an interior of an embodiment of an authentication device of the present invention;

FIG. 3 is a block diagram illustrating an embodiment of an authentication system in an access-controlled venue embodiment in accordance with the present invention; and

FIG. 4 is a flow diagram illustrating an embodiment of an authentication method of the present invention.

### DETAILED DESCRIPTION OF THE PREFERRED EMBODIMENTS

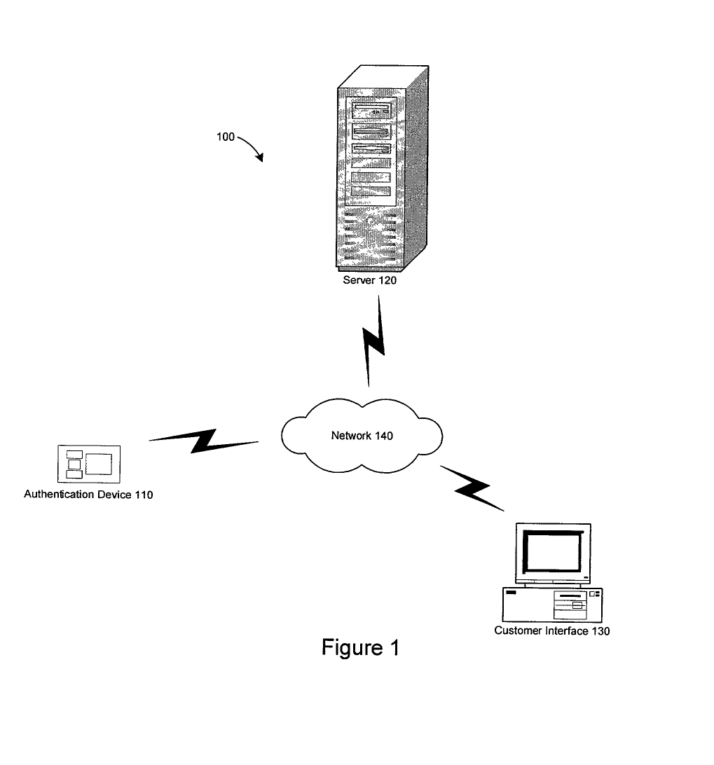

With reference to FIG. 1, an embodiment of an authentication system 100 of the present invention will be described. The authentication system includes an authentication device 110, a central server 120 and a customer interface 130. The authentication device 110, the server 120 and the customer interface 130 are preferably coupled by some means of communication, such as a network 140. As will be further discussed below, this communication may be continuous or intermittent. The network 140 may be wired, such as a fiber optic telephone network; wireless, such as satellite or cellular; or a combination thereof, such as the worldwide network broadly defined as the Internet.

The authentication device 110 may also take many forms. The authentication device 110 may be any device representative of a particular user, such as an identification card or other apparatus. In fact, the authentication device 110 may simply be the user, such as where a particular user is identified by a biological characteristic alone, such as a fingerprint, for example. However, in a preferred embodiment, the authentication device 110 is any device with appropriate processing power, typically an 8-bit or greater microprocessor or comparable device, and an adequate display, which may be beneficial for reasons further discussed below. Exemplary devices include cellular or other portable telephones, multi-function watches, personal digital assistants (PDAs) and smartcards having displays.

Thus, an integrated system 100 is provided in which identification information may be transferred via physical or contactless means between an authentication device 110 and a back-end mainframe such as a server 120. Some form of customer interface 130 may also be provided for providing authentication and other information to the server 120 if necessary. Exemplary customer interfaces 130 include ticket kiosks, networked personal computers (PCs), etc., and may be an authentication device 110 itself. Whether a customer interface 130 need be a part of the system 100 depends on a particular application of the present invention, as will be apparent to one skilled in the art in light of the description contained herein.

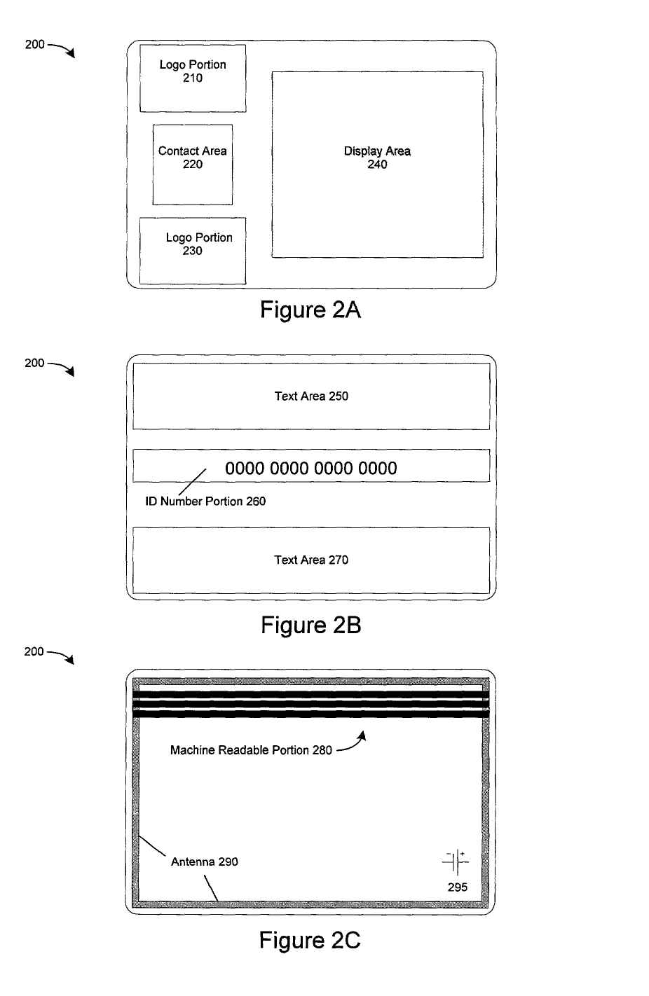

FIGS. 2A, 2B and 2C illustrate in greater detail an embodiment of the authentication device 110 of FIG. 1 as an authentication device 200. The authentication device 200 may be, for example, a smartcard. However, FIGS. 2A, 2B and 2C are not intended to be limited to such, but are instead representative of many variations of an authentication device 200, as will be further discussed below. Generally, FIG. 2A illustrates an obverse side of the authentication device 200, FIG. 2B the reverse side and FIG. 2C a view of an interior of this embodiment of the authentication device 200.

Referring to FIG. 2A, the obverse side of this embodiment of the authentication device 200 includes logo portions 210 and 230, which may be fixed image fields for, for example, branding by a sponsoring entity. This side of the device also further includes a display area 240. The display area 240 preferably includes an active, or variable, display. The use of a variable display allows, for example, large quantities of information to be selectively displayed in a relatively small area, and allows changing information to be continually refreshed as desired so as to be kept current. Information to be displayed may be maintained within the display, buffered via a memory element, processed and displayed concurrently with receipt of the information from an external source, or in any other known manner.

In a preferred embodiment, the display area 240 includes a display having a non-volatile and/or bistable memory, such that text or an image or other displayed information remains in memory and/or on the display after power is removed, indefinitely, until new display information is provided to the display. In one embodiment, a display material itself possesses bistable memory characteristics, thereby providing the preferred persistent display. Authentication data or other information may thereby be displayed when needed, as will be further discussed below. In such an embodiment, an optional internal power source 295 (see FIG. 2C) would be unnecessary, as any power required for updating the display may be provided externally. Such a display also tends to be more energy efficient than one that requires power to be applied for display information to be viewed. One skilled in the art will appreciate that such features may be particularly advantageous in a smartcard embodiment of the authentication device 200.

Furthermore, in a preferred embodiment, the display area 240 includes a display that is point-addressable. That is, unlike certain liquid crystal displays (LCDs) and light-emitting diode (LED) displays, for example, the display preferably includes a matrix of pixels that can be individually activated or deactivated. For example, the display may comprise a grid of pixels addressable via x-y axis coordinates, wherein each coordinate location includes its own transistor or other device that may be selectively activated.

The display included in the display area 240 may be, but is not limited to, a commercially available Immedia display from E Ink Corporation, Cambridge, Mass.; a Gyricon display from Gyricon Media, Inc., Palo Alto, Calif. (a spin-off of Xerox Corporation, Stanford, Conn.); or a paper-thin display of a type having toner sandwiched between plastic, for example, as is currently in prototype stage at Canon, Inc., Tokyo, Japan.

The display area may be any desired size, or may even be omitted if desired. In an alternative embodiment, the display area may even cover the entire area of the authentication device 200. Preferably, however, a size of the display area 240 is chosen such that other features can be provided on the obverse of the authentication device 200 as well. Of course, countless variations are contemplated, and may depend on a size of the device itself, the information intended to be displayed, and other functionality desired to be available from the authentication device 200. In a smartcard embodiment, a size of the authentication device 200 preferably approximates that of a standard credit card, such as about 85 millimeters (mm) by 55 mm and from about 0.5 mm or less to about 2 mm in thickness. In one embodiment, the size of the authentication device 200 is chosen to conform to the International Standards Organization (ISO) size of 85.6 mm by 53.98 mm. In this embodiment, the display area 240 is preferably approximately 50 mm by 50 mm, while the logo portions 210 and 230 are approximately 15 mm by 30 mm and 20 mm by 30 mm, respectively.

The obverse of the authentication device 200 may further include a contact area 220. The contact area 220 can provide a means to charge an internal power source 295 (discussed below) of the authentication device 200, read identification, authentication or other information from the authentication device 200, drive and/or update a display area 240 of the authentication device 200, encode the authentication device 200 with identification or other information, etc. Many of these functions may also be performed through contactless means as well if desired.

As illustrated by FIG. 2B, a reverse side of this embodiment of the authentication device 200 includes text areas 250 and 270 and identification (ID) number portion 260. In one embodiment, one of the text areas 250 and 270 is replaced with a further ID means, such as a barcode or matrix code, as will be further discussed below.

As can be seen in FIG. 2C, an interior of the authentication device 200 may be provided with, as a further means of unique identification, a machine-readable portion 280. For example, the machine-readable portion 280 may contain magnetically-encoded information. In one embodiment, the machine-readable portion 280 comprises up to three ISO defined backward-compatible magnetic stripes. In this particular embodiment, the three stripes may be enabled, for example, for 79 alphanumeric characters at 210 bpi, 40 numeric characters at 75 bpi and 107 numeric characters at 210 bpi, respectively. Of course, many alternatives are contemplated, such as where the number of stripes and the character and capacity of information storage are varied. In addition, as mentioned above, optical ID means are contemplated as well. For example, an optically-readable identifier such as a barcode or matrix code may be used in addition to or instead of any or all of the magnetic portions in the machine-readable portion 280. These codes may be permanent, or may be changeable, as with barcodes that are printed from a home PC, for example, for use on particular entitlements, such as single events or limited-use discounts.

The authentication device 200 may also contain means for wireless or proximity communication, such as a wireless transmitter/receiver (not shown) and an associated antenna 290. This antenna 290 may be a radio frequency (RF) antenna, for example, for communicating with a customer interface 130. For powering the display area 240, memory means, communication devices, etc., the authentication device 200 may further be optionally provided with an internal power source 295, such as a lithium/lithium ion battery or comparable power source known in the art, if desired. However, as discussed above, in an embodiment where a bistable display is utilized, for example in a smartcard, an internal source of power is unnecessary for powering the display.

Although not illustrated in FIGS. 2A-2C, an authentication device 200 of the present invention also preferably includes a type of integrated circuit chip or other portion that includes such features as a processor and logic capability and/or means for data storage, such as a read/write memory. Likewise, a smartcard of the present invention may be provided with these features, including a microprocessor and memory or other data storage capability. Such features are known in the art and may be included in many multi-function devices that may be used as authentication devices, such as cell phones, PDAs, watches, etc.

In an authentication device 110 of the present invention, a processor may be used as, or may include, appropriate drive electronics for providing data to the display area 240, as will be understood by one skilled in the art. The processor may also be involved in communication with a device at an access-controlled venue, for example, such as where the processor is enabled for processing authentication information received at the venue. However, in one embodiment, the display area 240 includes a display capable of and/or enabled for bistable performance, thus requiring power only for updating. This updating may occur at a gateway or other venue location such as a box office or stadium gate, at home via a home PC or peripheral, at a local terminal such as a kiosk or automated teller machine (ATM), by a handheld terminal, etc. Thus, displayed information is retained, with a need for power, processing, etc., until the applicable authentication device 110 is again updated.

In an authentication device 110, memory may provide information such as discussed above to a processor and or display. Memory may also be used to provide further functionality to an authentication device 110 or system of the present invention. For example, memory may store user preferences, such as display preferences or others, or various system data. Memory may also store information related to promotions available through an authentication system, as is further discussed below.

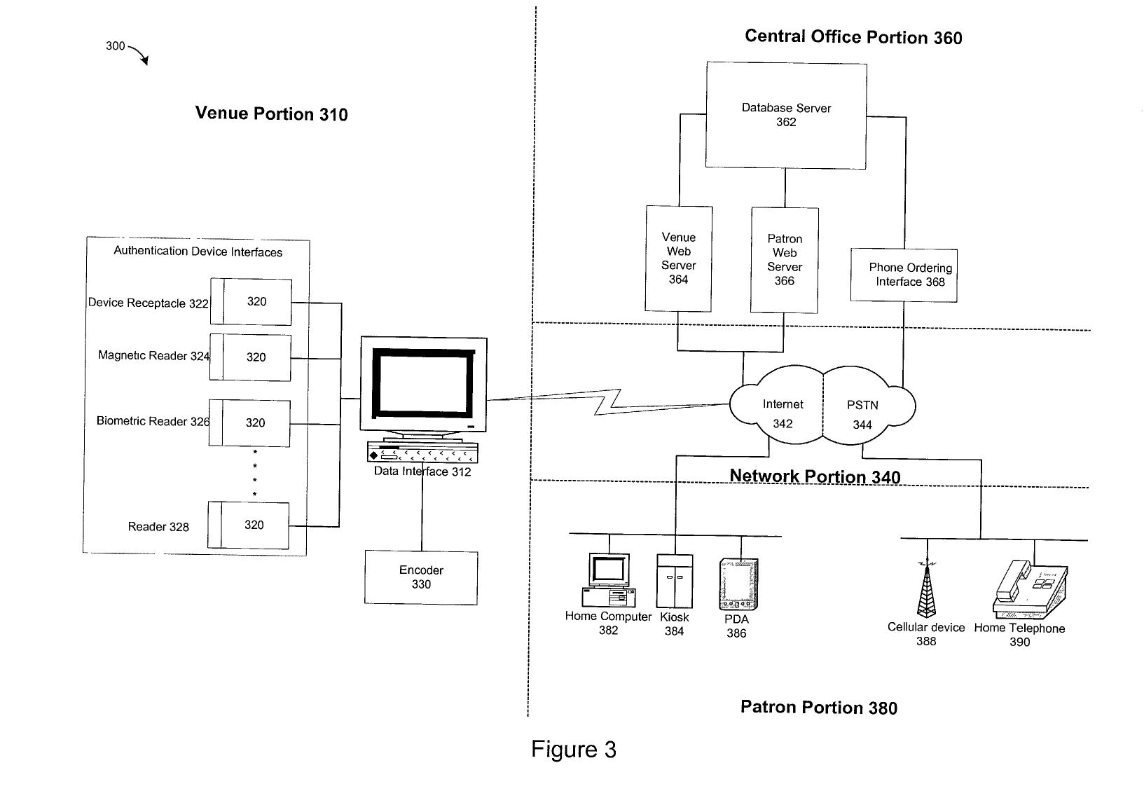

Referring next to FIG. 3, an embodiment of an authentication system of the present invention is illustrated as a system 300. In this embodiment, for purposes of illustration, the authentication system 300 is described with reference to permitting controlled access to a particular venue, for example. The system 300 includes a venue portion 310 coupled to a central office portion 360 through a network portion 340. A consumer or patron portion 380 is coupled to the venue portion 310 and the central office portion 360, also through the network portion 340.

The venue portion 310 represents any access-controlled venue, such as concert hall, a sports facility, an amusement park, a gate at an airline terminal or train station, etc. The venue portion includes a data interface 312 coupled to the network portion 340. The data interface 312 may be hardwired to the network portion 340, or may be a wireless unit. In one embodiment, the data interface 312 includes a computer terminal, as illustrated, or other such device at the venue.

Coupled to the data interface 312 are one or more authentication device interfaces 320. These authentication device interfaces 320 may include any of a variety of devices for reading from and/or sharing data with an authentication device. This data sharing may be through direct contact, close proximity, or by wireless means providing a greater range. In addition, the authentication device interfaces 320 may be used alone, or in conjunction with any other reading device represented generally as a reader 328. Such a reader 328 may comprise an authentication device receptacle 322 having one or more contacts for coupling with an authentication device such as at a contact area 220 (see e.g., FIG. 2A). These contacts may be used for power supply or replenishment. The contacts may also provide for data exchange, such as for updating a display area 240. Alternatively, one or more authentication device encoders 330 may be provided for the same purpose.

In another embodiment, a magnetic reader 324 is used for extracting from a magnetic stripe an encoded ID number or other identifying information from an authentication device. Other alternatives will be readily apparent to one skilled in the art.

Individual authentication device interfaces 320 may also be utilized in conjunction with other types of readers, such as for verification purposes. For example, in yet another embodiment, a biometric reader 326 is provided for detecting such biological features as a fingerprint or retinal structure. The biometric reader 326 may also be used alone, in reliance solely on a detected biological feature for authorization. In either case, the detected information may then be compared with data representing the same that is readable from the authentication device itself, preferably by the authentication device interface 320 or reader 328. Alternatively, the comparison data may be stored at the central office portion 360 of the system 300, thereby providing greater security by permitting authentication based on the patron alone, which obviates the need for an authentication device 110 and removes that avenue of potential fraud. In such an embodiment, the authentication device may instead or additionally contain meta-data indicating that the patron has provided data for biometric comparison. This data may lead to initiation of a data link to the central office portion 360 where the actual authentication data, such as a retinal description or fingerprint map, may be stored. Of course, numerous combinations of the above-described authentication device interfaces 320, readers 328 and other devices, are contemplated as well. For example, any of the above arrangements may be used in conjunction with a confidential personal identification number (PIN) assigned to or selected by a patron.

Thus, as will be appreciated from the above discussion by one skilled in the art, multiple levels of security are contemplated. In one embodiment, an account number or member number on the authentication device, or again, a biological characteristic of a user, may be sufficient. In another embodiment, more may be required of the user, such as the provision of a PIN. Such may be advantageous for remote transactions, such as purchases by phone or the Internet, for example. In yet another embodiment, still further security provisions may be in place. For example, a secure data handshake may be required between the authentication device and an authentication interface. In this embodiment, a PIN and/or verification via a certain biological feature may further be required.

With continued reference to FIG. 3, the network portion 340 facilitates information exchange between the venue portion 310, the central office portion 360 and the patron portion 380. The network portion 340 may comprise any physical or wireless network or a combination thereof, for example, such as the Internet 342. In addition, certain aspects of the present invention may be carried out over a public switched telephone network (PSTN) 344 or other means, as will be further discussed below.

In the present embodiment, the central office portion 360 represents a control center for the authentication system 300. The central office portion 360 includes a database server 362 for processing, storing and serving data associated with authentication. The central office portion 360 preferably includes a secure data interface, such as a venue web server 364 or patron web server 366 between the database server 362 and the network portion 340. The central office portion 360 may also include an operator-based and/or touchtone-based phone interface 368 coupling the central office portion 360 to the PSTN 344 of the network portion 340. The phone interface 368 may provide a means for a user to place an order for authentication or to make other requests, or to obtain information, such as via an automated or operator-based help line.

The patron portion 380 preferably represents a consumer aspect of the authentication system 300. For example, the patron portion 380 may provide a user a means to access the central office portion 360, through the network portion 340, for the purpose of purchasing a ticket for admittance to a particular venue. Thus, the patron portion 380 may include a home computer 382 for conducting online transactions, a physical ticket kiosk 384, a personal digital assistant (PDA) 386 or other means, each of which may be coupled to the central office portion 360 via the network portion 340. The patron portion 380 may further represent a cell phone 388 or home phone 390, each typically coupled in some capacity to the PSTN 344. Of course, one skilled in the art will recognize that these devices are listed by way of example only. Further devices are available, such as Internet-ready phones and PDAs, communication-enabled PDAs, etc., which combine and share features of the mentioned devices.

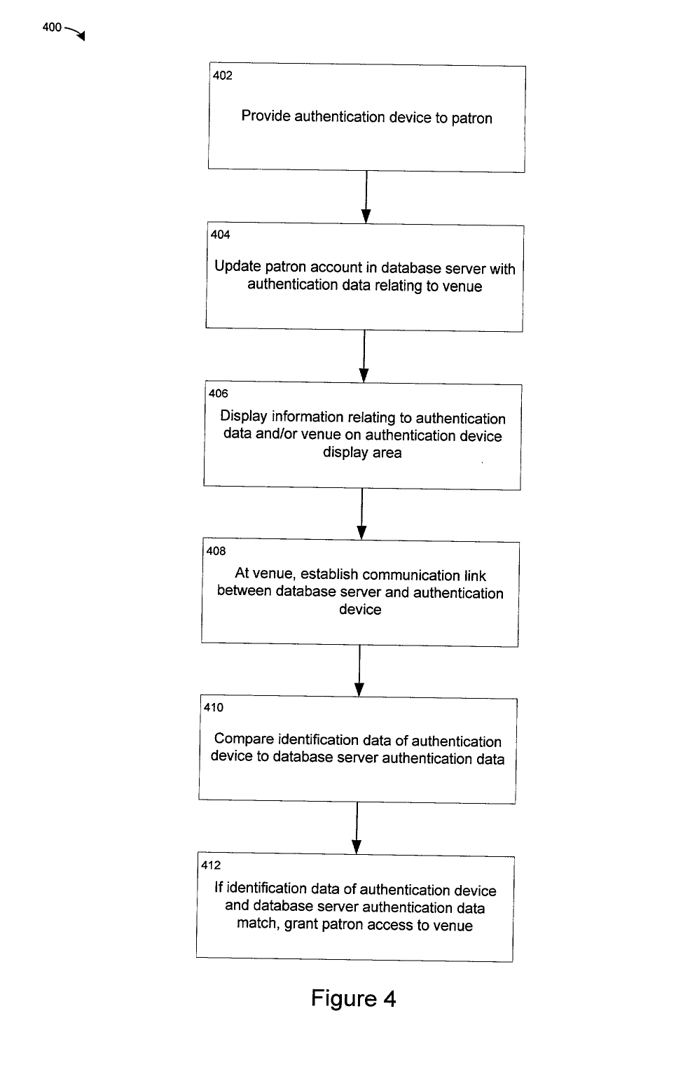

Operation of an authentication system 300 of the present invention will now be described with reference to FIG. 4. In one embodiment, a method 400 as illustrated may be representative of a typical method carried out in practicing the present invention. Preferably, the patron will at some point in time register with the system 300. This may involve providing personal, biographical, demographic, financial or other information that will be stored at, and will be accessible by, the database server 362. One skilled in the art will appreciate that various amounts and types of information may be required of a patron, and various steps may optionally be taken to verify the same. For example, a favorable financial status or history may be required. Once any predetermined requirements have been satisfied, a personal account may then be created for the patron. The account will preferably be given some designator, such as, for example, a 16-digit account ID commonly used with a credit card, as discussed above. The patron may also be assigned a more complex unique identifier, such as an alphanumeric code, for verification purposes in higher security embodiments.

Having established an account, a patron is provided in step 402 with an authentication device 110. An account ID associated with a previously established account may be imprinted thereon if the authentication device 110 is a smartcard or other such device that may be appropriately imprinted. For example, the ID number portion 260 of the authentication device 200 may be used. This account ID, as well as the more complex alphanumeric code, is preferably further encoded in the machine-readable portion 280.

Countless authentication devices 110 are contemplated, such as cell phones, keyfobs, watches, pagers, etc., which may be similarly imprinted and/or encoded. In one embodiment, multiple devices may be concurrently enabled for use as authentication devices 110. For example, a smartcard may be issued as a primary authentication device 110 for a particular user's account, while one or more other usable devices, such as a Bluetooth™-enabled PDA, may be piggybacked onto the same user's account. In this embodiment, authentication or other functionality may be limited to a single device for each event, promotion, etc. For example, once a first device is used as a ‘ticket’ for admittance to a venue, the account will be flagged as ‘used’ for that event. Thus, subsequent admittance via a device on the same account, unless such has been prearranged and/or properly funded, may be blocked by a system of the present invention.

In another embodiment, the use of disposable authentication devices 110 is contemplated. For example, disposable smartcards may be provided that possess authentication functionality for a limited duration of time. In this manner, commemorative authentication devices can be issued that may be kept as a souvenir, such as for special events.

As a sample use of the system 300, the patron may decide to arrange a future use of an authentication device 110 to gain access to a controlled venue. Preferably, in order to initiate such an arrangement, the patron will access the database server 362 of the central office portion 360 of the system 300 through the network portion 340. This may involve using a home computer 382 connected to the Internet 342 or going to a ticket kiosk 384, which may be multi-function, such as an Automated Teller Machine (ATM) or a standalone structure, for example. In another embodiment, the patron may use a PDA 386 to select the event, such as where prior billing arrangements have been made. The patron may also elect to make contact using a home telephone 390 or cellular device 388 or other wireless device, which may optionally be coupled through the PSTN 344.

Whatever the means, the patron then preferably purchases a ‘ticket’ to an event of interest set to take place at the venue. However, no paper ticket need be issued. Instead, in step 404, the database server 362 is preferably updated via the patron web server 366 or phone ordering interface 368, with respect to an account of the patron, to include information relating to the access-controlled venue and event for which the patron made the purchase. In addition, the authentication device 110 itself may be updated as well. For example, an interface, such as an authentication device interface 320 as discussed above, may be provided at a ticket kiosk 384, or for connection to the patron's home computer 382.

The authentication device interface 320 may then communicate with the authentication device 110, by any of a variety of means, to provide to the authentication device 110 the patron's updated authentication information. It is then possible that certain or all of the authentication information can be displayed, such as on the display area 240 of an authentication device 200. Such a feature is especially useful in access-controlled venue applications, as information such as time, date, name and location of event, assigned section/row/seat, etc., may be displayed, if desired. Thus, an authentication device 110 of the present invention may act as a replacement not only for a ticket for admittance, but for a ticket stub as well, which may be displayed to ushers, security, etc. Note that information unrelated to the authentication may be displayed as well, including voucher information, such as a checked coat or valet-parked car number, advertising, such as identification of a sponsoring entity, personal reminders, etc. Information peripherally related to authentication may further be provided, including promotional information, such as where a certain number of admittees, e.g. ‘the first 100 guests,’ are entitled to a free or discounted item. Such promotions may also be offered for repeat customers. For example, a viewer of four movies may be entitled to admission to a fifth for free. Admittance and related data for such a promotion may be stored in memory of an authentication device 110, or alternatively in memory at or in communication with the system 300 itself, such as at the central office portion 360. Any of the above information may be displayed in step 406.

When the date of the event for which the patron made the above-discussed purchase arrives, the patron preferably carries the authentication device 110 to the appropriate access-controlled venue. Again, this venue is preferably equipped with a data interface 312 and any of a number of varieties of authentication device interfaces 320, with which a communication link may be established in step 408 between the database server 362 and the authentication device 110. At the venue, the patron may be asked to present the authentication device 110 for reading, such as by a magnetic reader, scanner, or other device known in the art. Alternatively, the patron may simply pass or carry the card through a proximity area in which the card may be read without contact. Likewise, data exchange and/or supply of power, as discussed above, may occur through contactless means; data exchange via such conventions as Bluetooth™ or others and supply of power through inductive coupling in a magnetic field, for example.

At the venue, one embodiment of the present invention provides to personnel controlling access information relating to an identity of a possessor of an authentication device 110, such as through an authentication device interface 320. That is, when authentication is verified, a patron's name, for example, may be available to the personnel, such that personal greeting may be extended to the entering patron if desired.

Also at the venue, any of a plurality of levels of security may be provided. In one embodiment, data link is established between the data interface 312 and the database server 362 by way of a data handshake with the authentication device 110. As will be appreciated by one skilled in the art, this handshake may be brief, and as discussed above, may be through physical contact or wireless/proximity means. Subsequently, the data interface 312 will communicate to the database server 362 patron information or authentication device 110 identification information. The database server 362, if the identification information is recognized, will return authentication information to the data interface 312 via the network portion 340. If the authentication information in the database server 362 and the authentication device 110 identification information are matched upon comparison in step 410, the patron has demonstrated authorization to enter the venue, and may be allowed to do so in step 412.

Of course, depending on preferences of an operator of the venue, the patron may further be required to verify proper possession of the authentication device 110, such as by providing a PIN, biometric information, or other data. In addition, it should be noted that the above steps are provided by way of example only, and need not all be present in each application, need not be performed in the stated order, may be repeated and may include additional intervening steps. For example, the display may be updated a second time in step 412 and/or again thereafter.

Once at and admitted to the access-controlled venue, or at any other time for that matter, the patron may refer to a display area of the authentication device 110 for venue or event information. If this information was not provided to the authentication device 110 at the time the patron purchased authorization to the venue, the authentication device 110 may alternatively be updated with the information at the time the patron demonstrates that authorization at the venue, such as by an authentication device encoder 330. In one embodiment, authentication device encoders 330 are used to update authentication device displays with venue and/or event or other information, including section/row/seat information, changes in entertainment lineup, promotional opportunities, etc. The updating of some of this information, if available in advance, may also occur during an interim period, such as at any of a plurality of centrally-located or even personal authentication device access centers, in embodiments where the same are part of the authentication system 300. Such access centers may comprise a user's home personal computer having an authentication device 110 reader, a public kiosk or even a handheld device, such as may be carried by individuals controlling venue access. These access centers may also include authentication device encoders 330 if desired. Furthermore, in an embodiment where a wireless-enabled authentication device 110 is used, such updates may occur continuously in real-time.

The above example, whereby a patron prearranges authorization to enter an access-controlled venue, and uses an authentication device to demonstrate the same, has been provided as an illustrative example only. Countless other applications of the authentication device and associated system and method of the present invention are contemplated as well. For example, an authentication device may entitle a possessor to discounts on goods and/or services as a reusable and variable coupon. Likewise, an authentication device may be used as a frequent or preferred customer device, tracking purchases or other activities and entitling a member to preferential treatment, such as in a loyalty program. In one embodiment, a patron may earn entitlement to a free admission or food item, for example, upon entering an establishment, such as a movie theater, on a predetermined number of occasions.

A system and method of the present invention may further use an authentication device as debit or credit device, such as for tallying multiple entrances to controlled venues or for deducting from funds prepaid for the same purpose. Future entrances may be monitored in a similar manner, and may be coupled with a reservation system, such as for parking spaces or dinner tables. Furthermore, it is contemplated that authentication devices such as smartcards may possess functionality of traditional credit cards, phone cards, ATM cards and others as well, if desired.

While various embodiments of the invention have been described, it will be apparent to one of ordinary skill in the art that many more embodiments and implementations are possible that are within the scope of this invention. For example, the present invention may be practiced with any desired authentication device. That is, regarding any discussion above relating to a smartcard, one skilled in the art will appreciate that any authentication device (examples of which have been provided herein) having appropriate features may be substituted for the smartcard. Furthermore, the present invention is not restricted to use with the Internet or any hardwired system, but may alternatively be practiced on any network, physical, wireless or otherwise. Accordingly, the invention is not to be restricted except in light of the attached claims and their equivalents.

What is claimed is:

1. A portable authentication device, comprising:
a body;
a contact area disposed in said body;
an identification portion disposed in said body;
a display area disposed in said body and including an active display enabled for bistable performance; and
a processor, disposed in said body, for providing data to said active display area.

2. The device of claim 1, said body comprising:
a card approximating a size and shape of a standard credit card.

3. The device of claim 2, wherein said card is approximately 85 millimeters (mm) in length, 55 mm in width and 1 mm thick.

4. The device of claim 1, wherein said portable authentication device is enabled for communication with an authentication device interface, said processor being enabled for processing authentication information received from the authentication device interface.

5. The device of claim 1, said contact area further comprising:
a contact enabled for receiving externally-supplied power.

6. The device of claim 1, said contact area further comprising:
a contact enabled for communication of data between said authentication device and an authentication device interface.

7. The device of claim 1, said active display area comprising:
a variable display;
wherein said variable display is enabled for bistable display of authentication information.

8. The device of claim 1, further comprising:
a machine-readable portion, coupled to said body, enabled for storage of machine-readable data.

9. The device of claim 8, wherein said machine-readable portion comprises at least one of a magnetic strip and an optically-readable portion.

10. The device of claim 1, further comprising:
a communication portion, coupled to said body, for enabling said authentication device for wireless communication between said authentication device and an authentication device interface.

11. The device of claim 10, said communication portion comprising:
a wireless transmitter/receiver.

12. The device of claim 11, said communication portion further comprising:
means for communicating data between said wireless transmitter/receiver and a location external to said authentication device.

13. The device of claim 12, wherein said means for communicating comprise an antenna embedded in said body.

14. The device of claim 1, further comprising:
a memory portion, disposed in said body, enabled for storing data.

15. The device of claim 14, wherein said memory portion stores biometric identification data of a patron.

16. The device of claim 15, wherein said memory portion stores data for at least one of display in said active display area, for user authentication, for patron preferences and for system data.

17. An authentication system, comprising:
a portable authentication device having an active display;
a database server; and
an authentication device interface, coupling said portable authentication device and said database server.

18. The system of claim 17, further comprising:
an authentication device reader, coupled to said authentication device data interface, for communicating directly with and identifying said portable authentication device.

19. The system of claim 17, further comprising:
a public network in communication with each of said portable authentication device, said database server and said authentication device interface.

20. The system of claim 17, further comprising:
a venue portion, coupling said database server and said authentication device data interface;
wherein said venue portion communicates authentication data associated with a venue to said authentication device interface upon detection of said authentication device.

21. The system of claim 17, further comprising:
a patron portion, coupling said database server and said authentication device interface;
wherein said patron portion communicates authentication data associated with a venue to said database server in response to a request by a patron.

22. The system of claim 17, further comprising:
a phone ordering interface, coupling said database server to a public network;
wherein said phone ordering interface communicates authentication data associated with a venue to said database server in response to a request by a patron received via a public switched telephone network (PSTN).

23. A method for authenticating a patron having an authentication device, comprising:
providing an authentication device having an active display;
updating a database server with authentication data associated with a venue;
displaying display data corresponding to the authentication data on the authentication device;
establishing a communication between the authentication device and the database server; and
deciding whether to grant the patron access to the venue based on the communication.

24. The method of claim 23, further comprising:
comparing identification data of the authentication device and the authentication data; and
granting to the patron access to the venue if the identification data of the authentication device and the authentication data match.

25. The method of claim 24, wherein the identification data is identifiable with the patron based on patron data stored in the database server.

26. The method of claim 23, further comprising:
verifying an association between the patron and the authentication device prior to said granting.

27. The method of claim 23, wherein said establishing is of a communication link between an authentication device interface located at the venue and the database server.

28. The method of claim 23, further comprising:
receiving a request from the patron for authorization to enter the venue;
wherein said updating is in response to the request.

29. The method of claim 28, wherein the request is received from a location remote to the database server.

30. The method of claim 23, wherein said establishing takes place over a public network.
